(19) United States
(12) Patent Application Publication
(10) Pub. No.: US 2015/0287514 A1
(43) Pub. Date: Oct. 8, 2015

(54) CHIP COIL COMPONENT AND BOARD FOR MOUNTING THE SAME

(71) Applicant: SAMSUNG ELECTRO-MECHANICS CO., LTD., Suwon-Si (KR)

(72) Inventor: Bong Sup LIM, Suwon-Si (KR)

(73) Assignee: SAMSUNG ELECTRO-MECHANICS CO., LTD., Suwon-Si (KR)

(21) Appl. No.: 14/320,087

(22) Filed: Jun. 30, 2014

(30) Foreign Application Priority Data
Apr. 2, 2014 (KR) 10-2014-0039321

(51) Int. Cl. H01F 27/28; H01F 27/29; H01F 27/06

(52) U.S. Cl. CPC H01F 27/2804; H01F 27/06; H01F 27/29; H01F 2027/065; H01F 2027/2809

(57) ABSTRACT

A chip coil component may include: a ceramic body in which a plurality of magnetic layers are stacked; and an internal coil part disposed inside the ceramic body and having a plurality of internal coil patterns disposed on the plurality of magnetic layers to be electrically connected. The ceramic body may include an active layer, which is a capacitance forming part, and first and second cover layers disposed on and below the active layer in a thickness direction of the ceramic body, and a thickness of the second cover layer may be greater than that of the first cover layer.

### CROSS-REFERENCE TO RELATED APPLICATION

This application claims the benefit of Korean Patent Application No. 10-2014-0039321 filed on Apr. 2, 2014, with the Korean Intellectual Property Office, the disclosure of which is incorporated herein by reference.

### BACKGROUND

The present disclosure relates to a chip coil component and a board for mounting the same.

An inductor, which is one of chip electronic components, is a representative passive element forming an electronic circuit along with a resistor and a capacitor to remove noise, and is combined with the capacitor using electromagnetic characteristics to configure a resonance circuit amplifying a signal in a specific frequency band, a filter circuit, or the like.

As the trend for miniaturization and thinness of various types of IT devices, such as communications devices, display devices, and the like, is accelerated, research has been continuously conducted in order to miniaturize various types of elements, such as inductors, capacitors, transistors and the like commonly used in such IT devices.

In line with this, inductors have rapidly come to be chip inductors which are relatively small in size, highly densified and able to be automatically surface-mounted, followed by developments in a thin film inductor manufactured by mixing a magnetic powder with a resin to form coil patterns on top and bottom surfaces of a thin insulating substrate through a plating process and a multilayer inductor manufactured by performing a series of processes of printing an internal conductive pattern on a magnetic layer, via hole punching, stacking, sintering, and the like.

Such a multilayer inductor may be operated as an inductor reflecting noise since reactance components are dominant in a low frequency range but may be operated as a resistor converting noise into heat and absorbing the heat due to an increase in resistance components in response to an increase in frequency. Therefore, when the inductor is operated as the resistor due to the increase in resistance components in a high frequency range, the multilayer inductor is called multilayer beads.

In the case of the multilayer inductor, deteriorations in an inductance L and a quality factor Q may occur due to an eddy current. Further, when the chip is mounted on a board, the chip may topple over, resulting in an increase in product defects.

### RELATED ART DOCUMENT

### Patent Document

(Patent Document 1) Japanese Patent Laid-Open Publication No. 2006-032430

### SUMMARY

An aspect of the present disclosure provides a chip coil component and a board for mounting the same capable of preventing deteriorations in an inductance L and a quality factor Q due to an eddy current in a manner such that an internal coil part is disposed to be close to a top surface of a ceramic body, and improving adhesion strength by allowing external electrodes to be formed to have different lengths on top and bottom surfaces of the ceramic body.

According to an aspect of the present disclosure, a chip coil component may include: a ceramic body in which a plurality of magnetic layers are stacked; and an internal coil part disposed inside the ceramic body and having a plurality of internal coil patterns disposed on the plurality of magnetic layers to be electrically connected, wherein the ceramic body may include an active layer, which is a capacitance forming part, and first and second cover layers disposed on and below the active layer in a thickness direction of the ceramic body, and a thickness of the second cover layer may be greater than that of the first cover layer.

A ratio of the thickness of the first cover layer and the thickness of the second cover layer may be 1:3.

The chip coil component may further include external electrodes disposed on both end surfaces of the ceramic body in a length direction of the ceramic body and top and bottom surfaces of the ceramic body to be connected to the internal coil part.

A length of a portion of the external electrode disposed on the top surface of the ceramic body in the length direction of the ceramic body may be less than that of a portion of the external electrode disposed on the bottom surface of the ceramic body in the length direction of the ceramic body.

A length of a portion of the external electrode disposed on the top surface of the ceramic body in the length direction of the ceramic body may be 50 μm, and a length of a portion of the external electrode disposed on the bottom surface of the ceramic body in the length direction of the ceramic body may be 150 μm.

The chip coil component may further include a marking pattern disposed on a bottom surface of the ceramic body provided as a mounting surface or a top surface of the ceramic body opposing the bottom surface of the ceramic body.

The plurality of internal coil patterns may be provided in an amount of N (4≦N, where N is a natural number) on the plurality of magnetic layers, and an n-th (n≦N, where n is a multiple of 2) internal coil pattern and an n−1-th internal coil pattern, based on an internal coil pattern closest to the bottom surface of the ceramic body among the N internal coil patterns, may have the same shape, and the n-th internal coil pattern and the n−1-th internal coil pattern may be connected to each other through a connection terminal.

The connection terminal may include at least two via electrodes.

According to another aspect of the present disclosure, a chip coil component may include: a ceramic body in which a plurality of magnetic layers are stacked; an active layer disposed within the ceramic body and configured to form capacitance by including a plurality of internal electrodes disposed to face each other, with at least one of the magnetic layers interposed therebetween; a first cover layer disposed above an uppermost internal electrode within the active layer; a second cover layer disposed below a lowermost internal electrode within the active layer and having a thickness greater than that of the first cover layer; and external electrodes disposed on both end surfaces of the ceramic body in a length direction of the ceramic body and on bottom and top surfaces of the ceramic body, wherein a length of a portion of the external electrode disposed on the bottom surface of the ceramic body in the length direction of the ceramic body may be greater than that of a portion of the external electrode disposed on the top surface of the ceramic body in the length direction of the ceramic body.

A ratio of the thickness of the first cover layer and the thickness of the second cover layer may be 1:3.

The length of the portion of the external electrode disposed on the top surface of the ceramic body in the length direction of the ceramic body may be 50 μm, and the length of the portion of the external electrode disposed on the bottom surface of the ceramic body in the length direction of the ceramic body may be 150 μm.

The plurality of internal electrodes may be provided in an amount of N (4≦N, where N is a natural number) on the plurality of magnetic layers and an n-th (n≦N, where n is a multiple of 2) internal electrode and an n−1-th internal electrode, based on an internal electrode closest to the bottom surface of the ceramic body among the N internal electrodes, may have the same shape, and the n-th internal electrode and the n−1-th internal electrode may be connected to each other through a connection terminal.

The connection terminal may include at least two via electrodes.

According to another aspect of the present disclosure, aboard for mounting a chip coil component may include: a printed circuit board on which first and second electrode pads are disposed; and the chip coil component disposed on the printed circuit board, wherein the chip coil component includes: a ceramic body in which a plurality of magnetic layers are stacked; an active layer disposed within the ceramic body and configured to form capacitance by including a plurality of internal electrodes disposed to face each other, with at least one of the magnetic layers interposed therebetween; a first cover layer disposed above an uppermost internal electrode within the active layer; a second cover layer disposed below a lowermost internal electrode within the active layer and having a thickness greater than that of the first cover layer; and external electrodes disposed on both end surfaces of the ceramic body in a length direction of the ceramic body and on bottom and top surfaces of the ceramic body to be connected to the internal electrodes.

A length of a portion of the external electrode disposed on the top surface of the ceramic body in the length direction of the ceramic body may be less than that of a portion of the external electrode disposed on the bottom surface of the ceramic body in the length direction of the ceramic body.

The plurality of internal electrodes may be provided in an amount of N (4≦N, where N is a natural number) on the plurality of magnetic layers and an n-th (n≦N, where n is a multiple of 2) internal electrode, and an n−1-th internal electrode, based on an internal electrode closest to the bottom surface of the ceramic body among the N internal electrodes, may have the same shape, and the n-th internal electrode and the n−1-th internal electrode may be connected to each other through a connection terminal.

The connection terminal may include at least two via electrodes.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a perspective view of a chip coil component according to an exemplary embodiment of the present disclosure;

FIG. 2 is a cross-sectional view of the chip coil component of FIG. 1, taken along line A-A′;

FIG. 3 is a perspective view of a marking pattern in the chip coil component of FIG. 1;

FIG. 4 is a perspective view of an inside of the chip coil component of FIG. 3;

FIG. 5 is a perspective view of an internal coil part in the chip coil component of FIG. 1;

FIG. 6 is a graph illustrating Q characteristics of the chip coil component according to the embodiment of the present disclosure;

FIG. 7A is a view illustrating a top surface of a ceramic body of the chip coil component according to the embodiment of the present disclosure;

FIG. 7B is a view illustrating a bottom surface of the ceramic body of the chip coil component according to the embodiment of the present disclosure;

FIG. 8 is an exploded perspective view of the chip coil component according to the embodiment of the present disclosure;

FIG. 9 is a perspective view of a board in which a chip coil component according to another embodiment of the present disclosure is mounted on a printed circuit board; and

FIG. 10 is a cross-sectional view of the board of FIG. 9 in which the chip coil component is mounted on the printed circuit board.

### DETAILED DESCRIPTION

Hereinafter, embodiments of the present disclosure will be described in detail with reference to the accompanying drawings.

The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

Chip Coil Component

Hereinafter, a chip coil component 100 according to an embodiment of the present disclosure will be described, and in particular, is described as a multilayer inductor by way of example, but is not limited thereto.

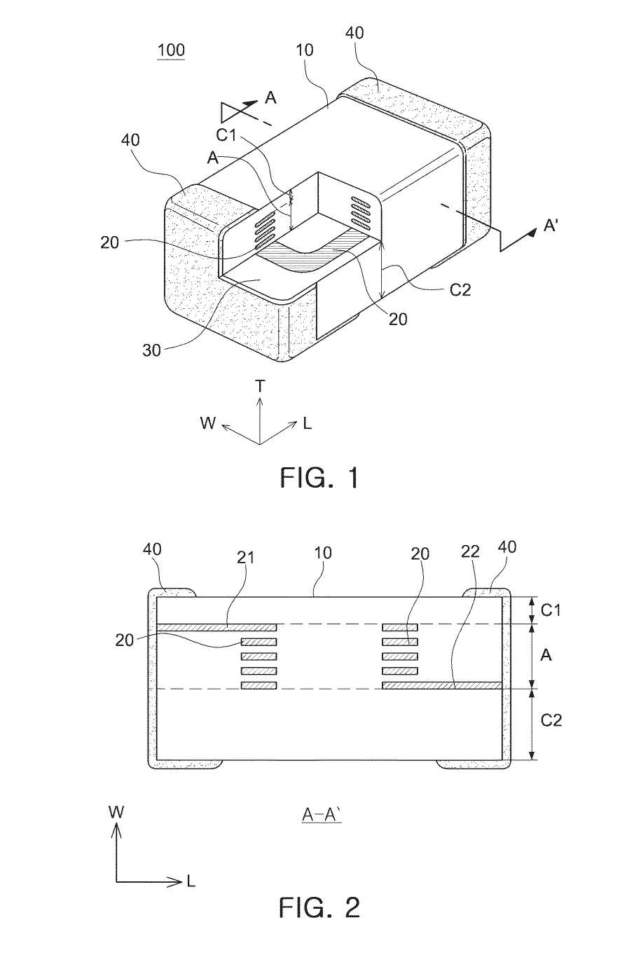

FIG. 1 is a perspective view of the chip coil component 100 according to the embodiment of the present disclosure.

Referring to FIG. 1, the chip coil component 100 according to the embodiment of the present disclosure may include a ceramic body 10 and an internal coil part 20. Meanwhile, the chip coil component 100 according to the embodiment of the present disclosure may further include external electrodes 40 formed on both end surfaces of the ceramic body 10 in a length direction thereof and portions of top and bottom surfaces of the ceramic body 10.

The ceramic body 10 may be formed by stacking a plurality of magnetic layers 30. The ceramic body 10 may have a bottom surface provided as a mounting surface, a top surface opposing the bottom surface, both end surfaces in the length direction, and both side surfaces in a width direction.

A shape of the ceramic body 10 is not particularly limited and may be, for example, a hexahedron. Directions of the hexahedron are defined to clearly describe exemplary embodiments of the present disclosure. As illustrated in FIG. 1, L, W, and T represent a length direction, a width direction, and a thickness direction, respectively. Here, the ‘thickness direction’ is the same concept as a direction in which magnetic layers 30 are stacked, that is, a ‘stacked direction’.

The plurality of magnetic layers 30, which are in a sintered state, may be integrated with each other such that boundaries between adjacent magnetic layers are not readily apparent without using a scanning electron microscope (SEM).

The plurality of magnetic layers 30 may each include known ferrite such as Mn—ZN-based ferrite, Ni—Zn-based ferrite, Ni—Zn—Cu-based ferrite, Mn—Mg-based ferrite, Ba-based ferrite, and Li-based ferrite.

FIG. 2 is a cross-sectional view of the chip coil component 100 of FIG. 1, taken along line A-A′.

Referring to FIGS. 1 and 2, the internal coil part 20 may be formed inside the ceramic body 10 by electrically connecting internal coil patterns formed on the plurality of magnetic layers 30.

In this case, the internal coil patterns formed on the plurality of magnetic layers 30 may be electrically connected to one another by via electrodes (not illustrated) to form the internal coil part 20, and the via electrodes may be formed by punching the top and bottom magnetic layers 30 in order to connect them to each another.

The internal coil pattern may be formed by printing a conductive paste including a conductive metal. As the conductive metal, metals having excellent electric conductivity may be used without being particularly limited. For example, silver (Ag), palladium (Pd), aluminum (Al), nickel (Ni), titanium (Ti), gold (Au), copper (Cu), platinum (Pt), or the like may be used alone or in combination.

The ceramic body 10 may include an active layer which is a capacitance forming part, a first cover layer C1 formed on the active layer A in the thickness direction, and a second cover layer C2 formed below the active layer A in the thickness direction.

Similar to the active layer A, the first and second cover layers C1 and C2 may be formed by sintering the plurality of magnetic layers 30. Further, similar to the active layer A, the plurality of magnetic layers including the first and second cover layers C1 and C2, which are in a sintered state, may be integrated such that boundaries between adjacent magnetic layers are not readily apparent without using a scanning electron microscope (SEM).

In the chip coil component 100 according to the embodiment of the present disclosure, a thickness of the first cover layer C1 may be less than that of the second cover layer C2.

In this case, a ratio of the thickness of the first cover layer C1 and the thickness of the second cover layer C2 may be 1:3.

Therefore, the internal coil part 20 may be disposed to be close to the top surface of the ceramic body in the thickness direction of the ceramic body 10.

Therefore, the chip coil component 100 according to the embodiment of the present disclosure may prevent deteriorations in an inductance L or a quality factor Q due to an eddy current.

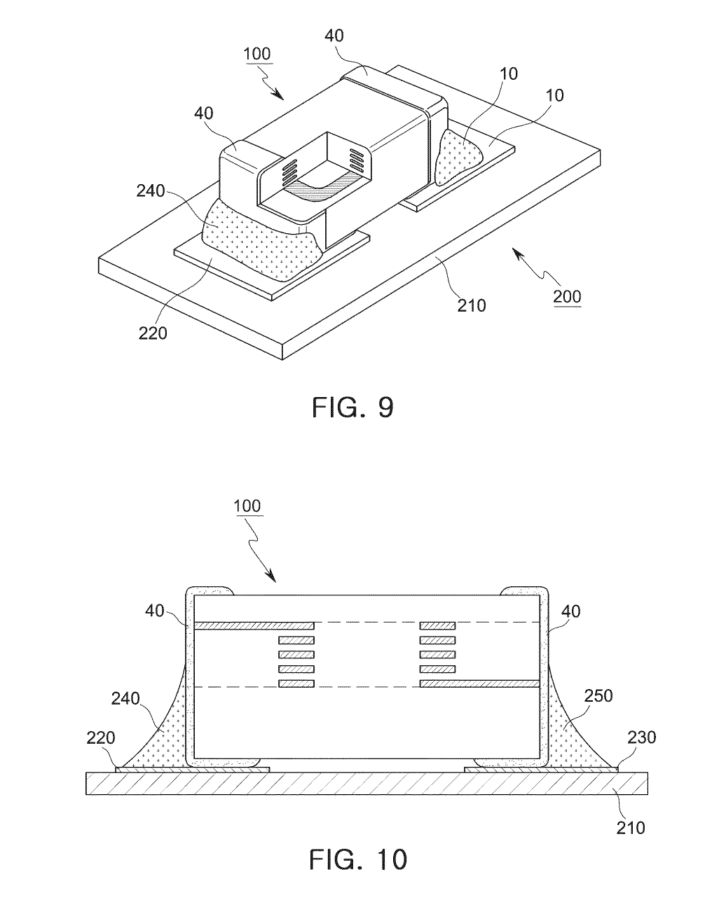

Describing in more detail, as illustrated in FIG. 9, the chip coil component 100 according to the embodiment of the present disclosure may be mounted on a printed circuit board 210.

In the case of the chip coil component according to the related art, the eddy current may be generated between the internal coil part and the printed circuit board. This phenomenon results from the eddy current generated from the printed circuit board itself as a reaction against a leakage current from the related art chip coil component, which may be considered as being due to the law of inertia.

That is, the eddy current may be resistance which appears to allow the chip coil component to be kept in a current state by itself, and may hinder a flow of magnetic flux to deteriorate the inductance L and quality factor Q properties of the chip coil component. Further, the eddy current may be largely generated as the internal coil part is close to the printed circuit board.

Therefore, in the chip coil component 100 according to the embodiment of the present disclosure with reference to FIGS. 1, 2, and 9, the thickness of the second cover layer C2 may be greater than that of the first cover layer C1 so as to considerably reduce the effect of the eddy current. That is, the internal coil part 20 may be disposed to be close to the top surface of the ceramic body in the thickness direction of the ceramic body 10.

Such a configuration may prevent deteriorations in the inductance L and quality factor Q properties of the chip coil component 100.

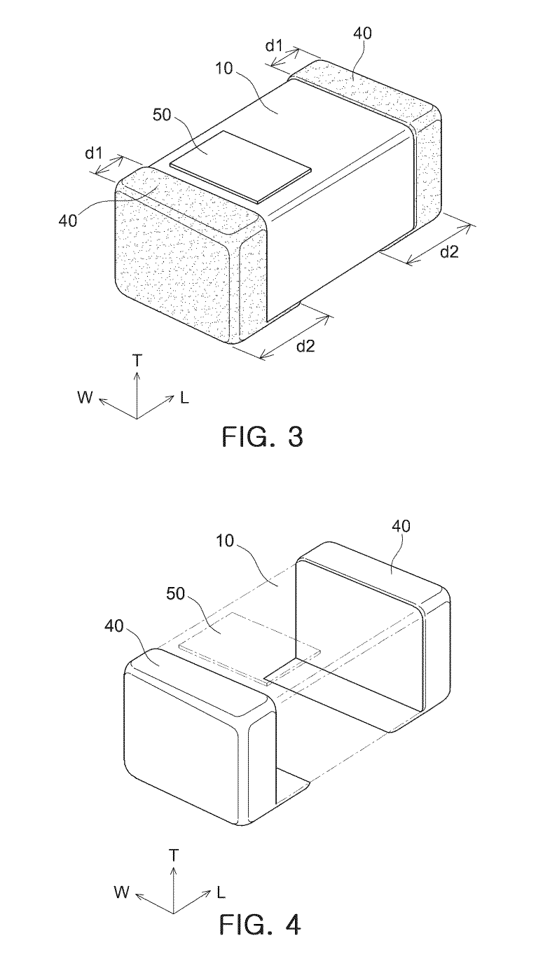

FIG. 3 is a perspective view of a marking pattern in the chip coil component of FIG. 1.

FIG. 4 is a perspective view of an inside of the chip coil component of FIG. 3.

Referring to FIGS. 2 to 4, the internal coil part 20 may include first and second lead parts 21 and 22 formed on the magnetic layers 30 to be exposed outwardly, and thus the internal coil part 20 may be electrically connected to the external electrodes 40 through the lead parts 21 and 22.

The external electrodes 40 may be formed of the same conductive material as that of the internal coil part 20, but are not limited thereto. For example, the external electrodes 40 may be formed of copper (Cu), silver (Ag), nickel (Ni), and the like.

The external electrodes 40 may be formed by applying a conductive paste prepared by adding glass frit to a metal powder to surfaces of the ceramic body and sintering the same. Further, the ceramic body 10 may be formed by stacking and sintering the plurality of magnetic layers 30. A shape and a dimension of the ceramic body 10 and the number of stacked magnetic layers 30 are not limited as those illustrated in the present exemplary embodiment.

In this case, a length d1 of a portion of the external electrode formed on the top surface of the ceramic body 10 may be smaller than a length d2 of a portion of the external electrode formed on the bottom surface of the ceramic body 10.

As an example, the length d1 of the portion of the external electrode formed on the top surface of the ceramic body 10 in the length direction of the ceramic body may be 50 μm and the length d2 of the portion of the external electrode formed on the bottom surface of the ceramic body in the length direction of the ceramic body may be 150 μm.

When the electronic component is highly integrated to be miniaturized, the portion of the external electrode formed on the top surface of the ceramic body 10 may contact a metallic can covering the electronic component, which may cause the occurrence of short-circuits, malfunction, or the like.

However, in the case of the chip coil component 100 according to the embodiment of the present disclosure, the length d1 of the portion of the external electrode formed on the top surface of the ceramic body 10 may be less than the length d2 of the portion of the external electrode formed on the bottom surface of the ceramic body 10, thereby considerably reducing the occurrence of short-circuits, malfunction, or the like.

Further, as the length d1 of the portion of the external electrode 40 formed on the top surface of the ceramic body 10 is reduced, a magnetic flux loss may be reduced and the Q characteristics may be improved.

Meanwhile, the length d2 of the portion of the external electrode 40 formed on the bottom surface of the ceramic body 10 may be designed to be greater than the length d1 so as to secure adhesion strength. That is, the chip coil component according to the embodiment of the present disclosure is manufactured by allowing the length d2 of the portion of the external electrode 40 formed on the bottom surface of the ceramic body 10 to be greater than the length d1 of the portion of the external electrode 40 formed on the top surface of the ceramic body 10, such that the chip coil component does not topple over even when the chip coil component is mounted on the printed circuit board, whereby the reliability of the chip coil component may be improved and the short-circuits resulting from the toppling of the chip coil component may be prevented.

According to the chip coil component 100 according to the embodiment of the present disclosure, a marking pattern 50 may be formed on one surface of the ceramic body 10 to identify surfaces of the ceramic body 10 to which the first and second lead parts 21 and 22 electrically connected to the external electrodes 40 are exposed.

For example, referring to FIGS. 3 and 4, the marking pattern may be formed on the top surface of the ceramic body 10.

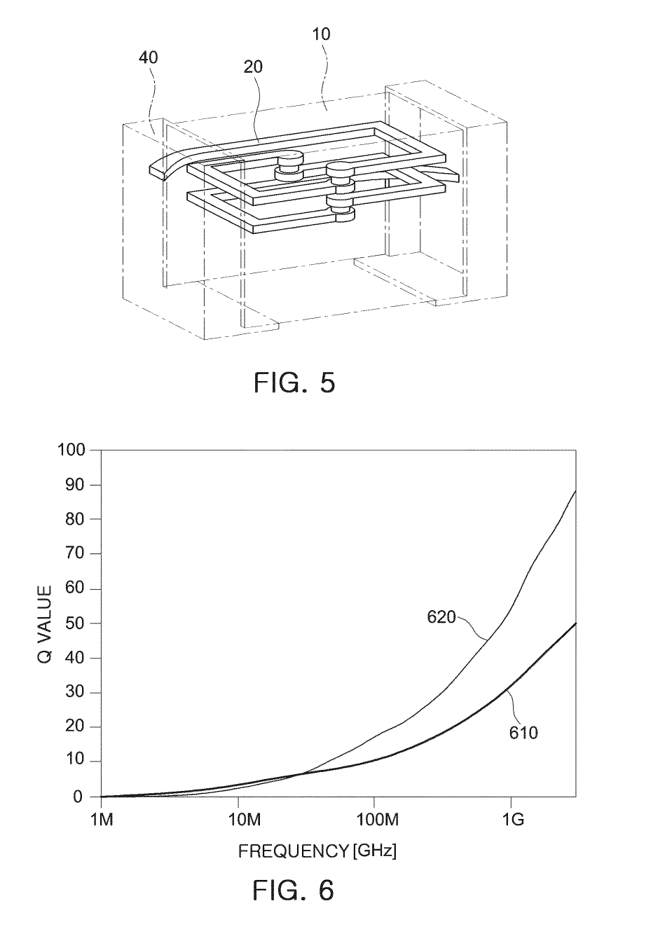

FIG. 5 is a perspective view of the internal coil part 20 in the chip coil component of FIG. 1.

Referring to FIG. 5, the internal coil part 20 of the chip coil component 100 according to the embodiment of the present disclosure may be disposed to be close to the top surface of the ceramic body 10 in the thickness direction of the ceramic body 10. As described above, such a configuration may prevent deteriorations in the inductance L and quality factor Q properties.

Meanwhile, the internal coil part 20 may be electrically connected to the external electrodes 40 through the first and second lead parts 21 and 22. In this case, the internal coil patterns are stacked and connected to one another via at least one via electrode between the magnetic layers to thereby form a single internal coil part 20.

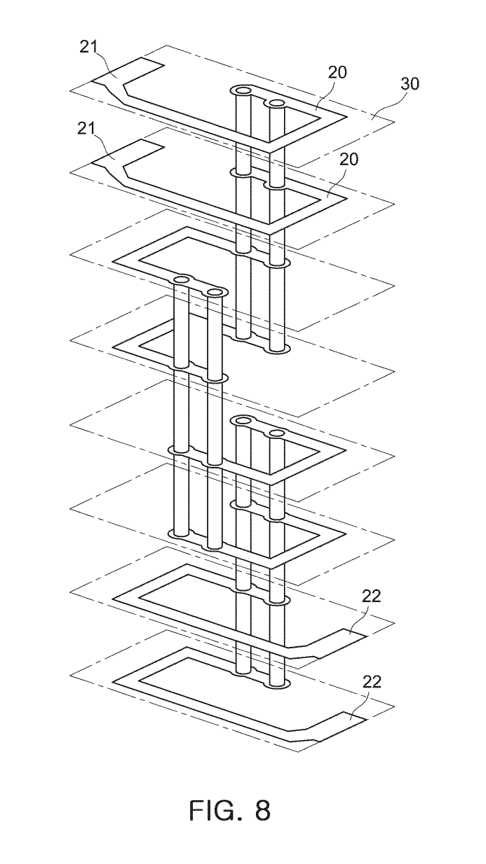

The shape of the stacked internal coil patterns in the internal coil part 20 will be described below with reference to FIG. 8.

FIG. 6 is a comparison graph illustrating the Q characteristics of the chip coil component 100 according to the embodiment of the present disclosure and the chip coil component according to the related art.

Referring to FIG. 6, it can be that Q characteristics 620 of the chip coil component 100 according to the embodiment of the present disclosure are higher than Q characteristics 610 of the chip coil component according to the related art.

The chip coil component 100 according to the embodiment of the present disclosure may have a structure in which the thickness of the first cover layer C1 is less than that of the second cover layer C2. This means that the internal coil part 20 may be disposed to be close to the top surface of the ceramic body 10 in the thickness direction of the ceramic body 10. Such a configuration may considerably reduce the effect of eddy current, whereby the Q characteristics may be further improved as compared to those of the related art chip coil component.

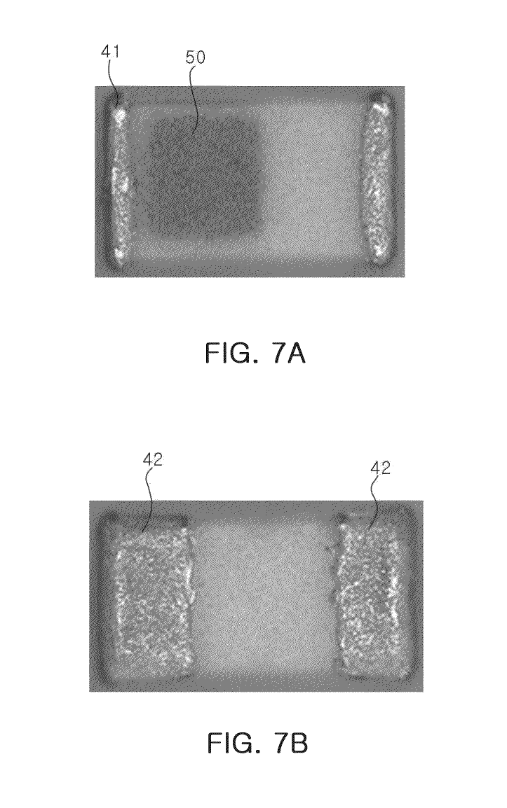

FIG. 7A is a view illustrating the top surface of the ceramic main body 10 of the chip coil component 100 according to the embodiment of the present disclosure.

FIG. 7B is a view illustrating the bottom surface of the ceramic main body 10 of the chip coil component 100 according to the embodiment of the present disclosure.

Referring to FIGS. 7A and 7B, in the chip coil component 100 according to the embodiment of the present disclosure, a length of a portion 41 of the external electrode formed on the top surface of the ceramic body 10 may be less than that of a portion 42 of the external electrode formed on the bottom surface of the ceramic body 10.

Further, the marking pattern 50 may be formed on the top surface of the ceramic body 10.

However, the portions 41 and 42 of the external electrodes and the marking pattern 50 have already been described, and a description thereof will be omitted.

FIG. 8 is an exploded perspective view of the chip coil component 100 according to the embodiment of the present disclosure.

In the chip coil component according to the embodiment of the present disclosure, the internal coil part 20 may be formed as a single structure as illustrated in FIG. 5 or may have a parallel structure in which the internal coil patterns are parallel to one another as illustrated in FIG. 8.

Referring to FIG. 8, N internal coil patterns 20 may be formed on the plurality of magnetic layers 30. In this case, N is a natural number equal to or greater than 4.

FIG. 8 illustrates that eight internal coil patterns are stacked (N is eight) by way of example, but the embodiment of the present disclosure is not limited thereto.

Based on an internal coil pattern closest to the bottom surface of the ceramic body 10 among the eight internal coil patterns, an n-th internal coil pattern and an n−1-th coil pattern may have the same shape. In this case, n is equal to or smaller than N and is also a multiple of 2.

That is, it may be seen that among the eight internal coil patterns, the internal coil pattern closest to the bottom surface of the ceramic body 10 and an adjacent internal coil pattern immediately disposed thereabove have the same shape. Therefore, the second lead part 22 may have a parallel structure in which the aforementioned coil patterns are parallel to each other.

Similarly, an internal coil pattern closest to the top surface of the ceramic body 10 and an adjacent internal coil pattern immediately disposed therebelow have the same shape, and thus, the first lead part 21 may also have a parallel structure in which the aforementioned coil patterns are parallel to each other.

Meanwhile, the n-th internal coil pattern and the n−1-th internal coil pattern may be connected to each other through a connection terminal which is configured of a plurality of via electrodes. That is, when the internal coil patterns have the same shape, the internal coil patterns may be connected to each other through the connection terminal which is configured of the plurality of via electrodes.

As an example, the connection terminal may be configured of at least two via electrodes.

That is, in the case in which at least two via electrodes are used, deterioration in the Q characteristics resulting from increased resistance in connection parts of the inter-layer via electrodes due to a weak connection between the internal electrode patterns may be prevented. Further, if the internal coil patterns are connected through only one via electrode in the same magnetic layer, the occurrence of open defects may be prevented and a reduction in inductance may also be prevented.

Board for Mounting Chip Coil Component

FIG. 9 is a perspective view of a board 200 in which a chip coil component 100 according to another embodiment of the present disclosure is mounted on a printed circuit board 210.

FIG. 10 is a cross-sectional view of the board 200 of FIG. 9 in which the chip coil component 100 is mounted on the printed circuit board 210.

Referring to FIGS. 9 and 10, the board 200 for mounting the chip coil component 100 according to the embodiment of the present disclosure may include the printed circuit board 210 on which the chip coil component 100 is mounted and first and second electrode pads 220 and 230 disposed on a top surface of the printed circuit board to be spaced apart from each other.

In this case, the external electrodes 40 of the chip coil component 100 may be electrically connected to the printed circuit board 210 by solders 240 and 250 in a state in which the external electrodes 40 are positioned to contact the first and second electrode pads 220 and 230.

The chip coil component 100 mounted on the printed circuit board 210 may include a ceramic body 10 formed by stacking a plurality of magnetic layers 30, an active layer A formed within the ceramic body 10 and configured to form capacitance by including a plurality of internal electrodes disposed to face each other, with at least one of the magnetic layers interposed therebetween, a first cover layer C1 disposed above the uppermost internal electrode within the active layer A, a second cover layer C2 formed below the lowermost internal electrode within the active layer A and having a thickness greater than that of the first cover layer C1, and the external electrodes 40 formed on both end surfaces of the ceramic body 10 in a length direction of the ceramic body 10 and top and bottom surfaces of the ceramic body 10 to be connected to the internal electrodes.

In this case, the thickness of the second cover layer C2 may be greater than that of the first cover layer C1 to thereby prevent deteriorations in inductance L and quality factor Q properties of the chip coil component 100 due to eddy currents.

Further, a length of a portion of the external electrode 40 formed on the top surface of the ceramic body 10 may be less than that of a portion of the external electrode 40 formed on the bottom surface of the ceramic body 10. That is, by increasing the length of the portion of the external electrode formed on the bottom surface of the ceramic body 10, when the chip coil component is mounted on the printed circuit board 210, adhesion strength may be improved and the toppling of the chip coil component may be considerably reduced.

Further, N (4≦N) internal electrodes may be formed on the plurality of magnetic layers 30. Based on an internal electrode closest to the bottom surface of the ceramic body 10 among the N internal electrodes, an n-th (n≦N, n is a multiple of 2) internal electrode and an n−1-th internal electrode may have the same shape, and the n-th internal electrode and the n−1-th internal electrode may be connected through a connection terminal configured of a plurality of via electrodes. In this case, the connection terminal may be configured of at least two via electrodes.

As set forth above, in the chip coil component and the board for mounting the same according to exemplary embodiments of the present disclosure, deteriorations in inductance L and quality factor Q properties due to eddy currents may be prevented. Further, adhesion strength may be improved by allowing a length of a portion of the external electrode formed on the bottom surface of the ceramic body to be greater than that of a portion of the external electrode formed on the top surface of the ceramic body.

While exemplary embodiments have been shown and described above, it will be apparent to those skilled in the art that modifications and variations could be made without departing from the spirit and scope of the present disclosure as defined by the appended claims.

What is claimed is:

1. A chip coil component, comprising:
a ceramic body in which a plurality of magnetic layers are stacked; and
an internal coil part disposed inside the ceramic body and having a plurality of internal coil patterns disposed on the plurality of magnetic layers and electrically connected to each other,
wherein the ceramic body includes an active layer, which is a capacitance forming part, and first and second cover layers disposed on and below the active layer in a thickness direction of the ceramic body, and
a thickness of the second cover layer is greater than that of the first cover layer.

2. The chip coil component of claim 1, wherein a ratio of the thickness of the first cover layer and the thickness of the second cover layer is 1:3.

3. The chip coil component of claim 1, further comprising external electrodes disposed on both end surfaces of the ceramic body in a length direction of the ceramic body and top and bottom surfaces of the ceramic body to be connected to the internal coil part.

4. The chip coil component of claim 3, wherein a length of a portion of the external electrode disposed on the top surface of the ceramic body in the length direction of the ceramic body is less than that of a portion of the external electrode disposed on the bottom surface of the ceramic body in the length direction of the ceramic body.

5. The chip coil component of claim 3, wherein a length of a portion of the external electrode disposed on the top surface of the ceramic body in the length direction of the ceramic body is 50 μm, and
a length of a portion of the external electrode disposed on the bottom surface of the ceramic body in the length direction of the ceramic body is 150 μm.

6. The chip coil component of claim 1, further comprising a marking pattern disposed on a bottom surface of the ceramic body provided as a mounting surface or a top surface of the ceramic body opposing the bottom surface of the ceramic body.

7. The chip coil component of claim 1, wherein the plurality of internal coil patterns are provided in an amount of N (4≦N, where N is a natural number) on the plurality of magnetic layers,
an n-th (n≦N, where n is a multiple of 2) internal coil pattern and an n−1-th internal coil pattern, based on an internal coil pattern closest to the bottom surface of the ceramic body among the N internal coil patterns, have the same shape, and
the n-th internal coil pattern and the n−1-th internal coil pattern are connected to each other through a connection terminal.

8. The chip coil component of claim 7, wherein the connection terminal includes at least two via electrodes.

9. A chip coil component, comprising:
a ceramic body in which a plurality of magnetic layers are stacked;
an active layer disposed within the ceramic body and configured to form capacitance by including a plurality of internal electrodes disposed to face each other, with at least one of the magnetic layers interposed therebetween;
a first cover layer disposed above an uppermost internal electrode within the active layer;
a second cover layer disposed below a lowermost internal electrode within the active layer and having a thickness greater than that of the first cover layer; and
external electrodes disposed on both end surfaces of the ceramic body in a length direction of the ceramic body and on bottom and top surfaces of the ceramic body,
wherein a length of a portion of the external electrode disposed on the bottom surface of the ceramic body in the length direction of the ceramic body is greater than that of a portion of the external electrode disposed on the top surface of the ceramic body in the length direction of the ceramic body.

10. The chip coil component of claim 9, wherein a ratio of the thickness of the first cover layer and the thickness of the second cover layer is 1:3.

11. The chip coil component of claim 9, wherein the length of the portion of the external electrode disposed on the top surface of the ceramic body in the length direction of the ceramic body is 50 μm, and
the length of the portion of the external electrode disposed on the bottom surface of the ceramic body in the length direction of the ceramic body is 150 μm.

12. The chip coil component of claim 9, wherein the plurality of internal electrodes are provided in an amount of N (4≦N, where N is a natural number) on the plurality of magnetic layers,
an n-th (n≦N, where n is a multiple of 2) internal electrode and an n−1-th internal electrode, based on an internal electrode closest to the bottom surface of the ceramic body among the N internal electrodes, have the same shape, and
the n-th internal electrode and the n−1-th internal electrode are connected to each other through a connection terminal.

13. The chip coil component of claim 12, wherein the connection terminal includes at least two via electrodes.

14. Aboard for mounting a chip coil component, the board comprising:
a printed circuit board on which first and second electrode pads are provided; and
the chip coil component disposed on the printed circuit board,
wherein the chip coil component includes:
a ceramic body in which a plurality of magnetic layers are stacked;
an active layer disposed within the ceramic body and configured to form capacitance by including a plurality of internal electrodes disposed to face each other, with at least one of the magnetic layers interposed therebetween;
a first cover layer disposed above an uppermost internal electrode within the active layer;
a second cover layer disposed below a lowermost internal electrode within the active layer and having a thickness greater than that of the first cover layer; and
external electrodes disposed on both end surfaces of the ceramic body in a length direction of the ceramic body and on bottom and top surfaces of the ceramic body to be connected to the internal electrodes.

15. The board of claim 14, wherein a length of a portion of the external electrode disposed on the top surface of the ceramic body in the length direction of the ceramic body is less than that of a portion of the external electrode disposed on the bottom surface of the ceramic body in the length direction of the ceramic body.

16. The board of claim 14, wherein the plurality of internal electrodes are provided in an amount of N (4≦N, where N is a natural number) on the plurality of magnetic layers,
an n-th (n≦N, where n is a multiple of 2) internal electrode and an n−1-th internal electrode, based on an internal electrode closest to the bottom surface of the ceramic body among the N internal electrodes, have the same shape, and
the n-th internal electrode and the n−1-th internal electrode are connected to each other through a connection terminal.

17. The board of claim 16, wherein the connection terminal includes at least two via electrodes.
